(19) United States
(12) Patent Application Publication
(10) Pub. No.: US 2020/0293966 A1
(43) Pub. Date: Sep. 17, 2020

(54) MERGED PRESENTATION OF DUPLICATE CONTACTS ACROSS SHARED CONTACT DIRECTORIES

(71) Applicants: Vishal GUPTA, Delhi (IN); Nikhil RAI, Delhi (IN)

(72) Inventors: Vishal GUPTA, Delhi (IN); Nikhil RAI, Delhi (IN)

(21) Appl. No.: 16/081,929

(22) PCT Filed: Sep. 2, 2016
(86) PCT No.: PCT/IB2016/055271

§ 371 Date: Sep. 3, 2018

(30) Foreign Application Priority Data
Mar. 2, 2016 (IN) 201611007410
Mar. 16, 2016 (IN) 201611009230

(51) Int. Cl. G06Q 10/06; G06Q 10/10; G06Q 50/00

(52) U.S. Cl. CPC G06Q 10/06312; G06Q 50/01; G06Q 10/107

(57) ABSTRACT

The present disclosure relates to contact linking and presentation of a merged view for duplicate contacts that exist in shared multiple phone books at a user level. Further, an ability to mark a particular contact related information as discarded is disclosed. It is further proposed that while creating a temporary merged view, such discarded information, when linked with other linked contact, is also enforced as discarded so as to prevent zombie information coming alive due to linking.

### FIELD OF THE INVENTION

The present disclosure is directed towards managing presentation of multiple duplicate contacts that are stored across one or more contact directories.

### BACKGROUND

The background description includes information that may be useful in understanding the present invention. It is not an admission that any of the information provided herein is prior art or relevant to the presently claimed invention, or that any publication specifically or implicitly referenced is prior art.

Having duplicate contacts/entries is a common problem in today's mobile phones/devices, wherein the duplication can not only be in the phone number of a contact but even for the contact's email id, contact name, social media handle, or any other contact information parameter.

Current solutions provide ways such as merging or deleting duplicate contacts in existing contact directories and therefore retaining only one entry. Although the phone number of such an entry may be correct, there is no surety that other contact information stored along with the phone number such as email id, category to which the contact belongs (such as alumni member or family or office team member), fax number, social media handle, or other contact information parameter is correct.

This problem further gets exaggerated in case these contact directories are being shared on multiple user devices. Shared contact directories that are group-sourced is a recent way of managing contacts on smartphones (also interchangeably referred to as mobile phones hereinafter). Such directories provide a further challenge of zombie data besides the issue of contact duplication elaborated above.

Currently there exists no solution to present a temporary merged representation of duplicate contacts showing also the contact directory source of each duplicate contact without actually merging duplicate contacts (i.e. there is no means currently to manage merging of duplicate contacts from multiple devices/contact directories except for a total merge operation, which is not efficient).

There is therefore a need in the art for a system and method that enables automatic determination of duplication of contacts across one or more contact directories, and based on such determination, creates and presents to the user a temporary merged view of all the duplicate contacts.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### SUMMARY

The present disclosure is directed towards managing presentation of multiple duplicate contacts that are stored across one or more contact directories.

In an aspect, the present disclosure relates to a system for presenting logically merged contact information of a first contact, said system including a non-transitory storage device having embodied therein one or more routines operable to present logically merged contact information; and one or more processors coupled to the non-transitory storage device and operable to execute the one or more routines, wherein the one or more routines include: a duplication detection engine, which when executed by the one or more processors that form part of a computing device of a second user intending to view merged contact information of the first contact, discovers existence of a unique identifier of the first contact across one or more contacts stored in a plurality of contact directories accessible to the second user, and wherein the plurality of contact directories comprise at least one crowd sourced shared contact directory having a first user and the second user and having at least the first contact as common, wherein the at least one crowd sourced shared contact directory is crowd sourced so as to discover new contacts automatically based on actions of multiple contacts that are already a part of the shared contact directory; and a merging engine, which when executed by the one or more processors, merges and presents contact information attributes of the one or more contacts stored in the plurality of contact directories that have the unique identifier of the first contact, wherein the merging engine logically unifies the contact information attributes to present the merged contact information without actually merging the contact information attributes.

In an aspect, the unique identifier can be any or a combination of first name, last name, email address, phone number, URL, photograph, address, a new contact information attribute, date based events, social media handle, or a part thereof. In another aspect, the computing device can be selected from any of a mobile phone, a smart phone, a tablet PC, a laptop, and a PDA.

In another aspect, the at least one crowd sourced shared contact directory is stored on a server or on a database that is accessible to the computing device. Furthermore, at least one contact directory of the plurality of contact directories is stored locally on the computing device.

In an aspect, the merged contact information can be presented along with directory information of the contact directories that the first contact forms part of and are also accessible to the second user. Furthermore, the directory information can include any or a combination of number of contact directories that the first contact forms part of, number of contacts in each contact directory that the first contact forms part of, and attributes of contacts that form part of the contact directories that the first contact forms part of.

In an aspect, the system enables the first user to discard an entry against a first contact information attribute of the first contact such that in case the entry exists against the first contact information attribute for the first contact across two or more contact directories, the second user views the entry as discarded in the merged contact information.

In another aspect, the first contact can be of the first user.

In another aspect, modification of an entry against a contact information attribute of the first contact in the merged contact information by the second user enables the modification to be performed in each instance of the first contact across the one or more contact directories that are accessible to the second user and store said entry against the contact information attribute for the first contact.

In an aspect, when, against a contact information attribute, multiple different entries exist across the one or more contacts having the unique identifier of the first contact, the merging engine presents all the multiple entries in the merged contact information. Also, in case the different entries against the contact information attribute loosely match with each other, the merged contact information only presents one of the losely matching entries. Similarly, when, against a contact information attribute, a given entry exists across the one or more contacts, the merging engine removes the duplicates and presents the entry only once against the contact information attribute in the merged contact information.

In another aspect, the duplication detection engine can discover the one or more contacts stored in the plurality of contact directories that have the unique identifier based on a loose match (say for instance, a match for phone number 9810617223 of a first user can be said to have been found when a phone number (contact information attribute)+91-9810617223 or 09810617223 is found in a contact directory) of the unique identifier so as to improve the accuracy of discovery.

The present disclosure further relates to a method for presenting logically merged contact information of a first contact, said method having the steps of discovering, using one or more processors that form part of a computing device of a second user intending to view merged contact information of the first contact, existence of a unique identifier of the first contact across one or more contacts stored in a plurality of contact directories accessible to the second user, and wherein the plurality of contact directories comprise at least one crowd sourced shared contact directory having a first user and the second user and having at least the first contact as common, wherein the at least one crowd sourced shared contact directory is crowd sourced so as to discover new contacts automatically based on actions of multiple contacts that are already a part of the shared contact directory; and merging and presenting, at the computing device, contact information attributes of the one or more contacts stored in the plurality of contact directories that have the unique identifier of the first contact, wherein the merging logically unifies the contact information attributes to present the merged contact information without actually merging the contact information attributes.

In an aspect, the present disclosure relates to contact linking and presentation of a merged view for duplicate contacts that exist across one or more shared/private contact directories (also interchangeably referred to as “phone books” or contact directories” hereinafter) to a user of such contact directories. Further, an ability to mark a particular contact related information as discarded is being disclosed in the instant disclosure. It is further proposed that while creating a temporary merged view (also interchangeably referred to as “logical merged view”, “logically merged view” or “virtual view”), such discarded information, when linked with other linked contacts, can also be enforced as discarded so as to prevent zombie information coming alive due to linking.

Aspects of the present disclosure provide a duplication detection engine (DDE) that is operatively coupled with a first computing device (such as a smartphone of a user), wherein the DDE is configured to retrieve/discover one or more contact directories that may be either stored locally on the first computing device or accessible from a common global database of contact directories that the first computing device is authorized to access. DDE can further be configured to identify duplicate contacts across the retrieved one or more contact directories using at least one unique identifier. In an aspect, the unique identifier can be the phone number of the contact whose duplicate entries exist across the one or more contact directories, or can be a combination of first and last name of the contact whose merged view is to be viewed, or can be the email address/home address/office address/or any other contact information attribute or a combination thereof, whose value is unique to the contact/user whose merged view is to be viewed. For instance, if the DDE is able to retrieve 5 contact directories (CDs), say CD-1, CD-2, CD-3, CD-4, and CD-5, three of which (say CD-1, CD-2, and CD-4) have a common contact for Alan having number 999-435-4368; three duplicate contacts can be said to have been identified by the DDE. It can also be possible, that CD-2, apart from storing the unique identifier, can also store say another phone number, say work number or another personal phone number. Other contact information such as email id, social media handle, URL, birthday details, address, photo etc., for Alan across the duplicate contacts may also be same or completely different or partially different.

Aspects of the present disclosure can further provide a merging engine that can be configured to, at the first computing device, logically/temporarily merge the duplicate contacts at its run-time to present a single merged view for each contact without actually merging the duplicate contacts across the contact directories. The proposed merging engine therefore may not change the entries in respective contact directories per se but can merge the duplicate entries only for the presentation to the user of the first computing device. Such a merged view can further give the number of contact directories in which duplicate entries exist, and/or number of duplicate entries for a given contact (such as 3 for Alan) across all contact directories. For instance, it may be possible that a given contact directory has multiple duplicate entries within itself, or it may also be possible that duplicate entries exist across multiple contact directories. In another aspect, the merging engine can further enable presentation of all contact directories that a given duplicate contact forms a part of.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an exemplary network architecture showing multiple contact directories that are stored in a common global database of contact directories, and enabling users to access one or more shared contact directories depending on whether they form part of the respective contact directories in accordance with an embodiment of the present disclosure.

FIG. 2 illustrates exemplary functional modules of the proposed system 200 for showing a merged view of duplicate contacts stored across one or more contact directories in accordance with an embodiment of the present disclosure.

FIG. 3 illustrates different contacts that are accessible to a user through one or more phone books in accordance with an embodiment of the present disclosure.

FIG. 4 illustrates an exemplary representation when the user actually clicks on a contact in accordance with an embodiment of the present disclosure.

FIGS. 5A and 5B illustrate exemplary representations showing merged view representations of instances of a contact across one or more contact directories in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms are used herein. To the extent a term used in a claim is not defined below, it should be given the broadest definition persons in the pertinent art have given that term as reflected in printed publications and issued patents at the time of filing.

Contacts duplication is a big issue since the beginning of mobile phones/devices. There are many de-duplication solutions that permanently merge or delete these contacts. The problem exponentially increases when users create multiple shared phonebooks that span across multiple user devices.

The present disclosure is directed towards managing presentation of multiple duplicate contacts that are stored across one or more contact directories.

The present disclosure is directed towards managing presentation of multiple duplicate contacts that are stored across one or more contact directories.

In an aspect, the present disclosure relates to a system for presenting logically merged contact information of a first contact, said system including a non-transitory storage device having embodied therein one or more routines operable to present logically merged contact information; and one or more processors coupled to the non-transitory storage device and operable to execute the one or more routines, wherein the one or more routines include: a duplication detection engine, which when executed by the one or more processors that form part of a computing device of a second user intending to view merged contact information of the first contact, discovers existence of a unique identifier of the first contact across one or more contacts stored in a plurality of contact directories accessible to the second user, and wherein the plurality of contact directories comprise at least one crowd sourced shared contact directory having a first user and the second user and having at least the first contact as common, wherein the at least one crowd sourced shared contact directory is crowd sourced so as to discover new contacts automatically based on actions of multiple contacts that are already a part of the shared contact directory; and a merging engine, which when executed by the one or more processors, merges and presents contact information attributes of the one or more contacts stored in the plurality of contact directories that have the unique identifier of the first contact, wherein the merging engine logically unifies the contact information attributes to present the merged contact information without actually merging the contact information attributes.

In an aspect, the unique identifier can be any or a combination of first name, last name, email address, phone number, URL, photograph, address, a new contact information attribute, date based events, social media handle, or a part thereof. In another aspect, the computing device can be selected from any of a mobile phone, a smart phone, a tablet PC, a laptop, and a PDA.

In another aspect, the at least one crowd sourced shared contact directory is stored on a server or on a database that is accessible to the computing device. Furthermore, at least one contact directory of the plurality of contact directories is stored locally on the computing device.

In an aspect, the merged contact information can be presented along with directory information of the contact directories that the first contact forms part of and are also accessible to the second user. Furthermore, the directory information can include any or a combination of number of contact directories that the first contact forms part of, number of contacts in each contact directory that the first contact forms part of, and attributes of contacts that form part of the contact directories that the first contact forms part of.

In an aspect, the system enables the first user to discard an entry against a first contact information attribute of the first contact such that in case the entry exists against the first contact information attribute for the first contact across two or more contact directories, the second user views the entry as discarded in the merged contact information. Such discard feature of the instant invention enables removal of zombie data, and therefore because of the crowd-source contact directories of the instant invention, change in status of a contact information attribute entry/value (say, landline phone number or email address or work phone number) as discard enables the same entry across multiple contact directories to be seen as discarded in the merged view. Zombie data is when a data is deleted in a crowdsourcing data, and it comes back alive repeatedly due to actions of other users during operations of merge, linking or appending information. Such zombie data is typically data such as old phone numbers or email addresses that are no longer active, and therefore in the instant invention, marking of a given contact information attribute value as discard can help the second user viewing the merged view to see the entry as discarded even if the same entry is not discarded in another contact directory that the first contact forms part of.

In another aspect, the first contact can be of the first user. In another aspect, the first contact may not be of first user and may instead belong to a non-user.

In another aspect, modification of an entry against a contact information attribute of the first contact in the merged contact information by the second user enables the modification to be performed in each instance of the first contact across the one or more contact directories that are accessible to the second user and store said entry against the contact information attribute for the first contact.

In an aspect, when, against a contact information attribute, multiple different entries exist across the one or more contacts having the unique identifier of the first contact, the merging engine presents all the multiple entries in the merged contact information. Also, in case the different entries against the contact information attribute loosely match with each other, the merged contact information only presents one of the losely matching entries. Similarly, when, against a contact information attribute, a given entry exists across the one or more contacts, the merging engine removes the duplicates and presents the entry only once against the contact information attribute in the merged contact information.

In another aspect, the duplication detection engine can discover the one or more contacts stored in the plurality of contact directories that have the unique identifier based on a loose match (say for instance, a match for phone number 9810617223 of a first user can be said to have been found when a phone number (contact information attribute)+91-9810617223 or 09810617223 is found in a contact directory) of the unique identifier so as to improve the accuracy of discovery.

The present disclosure further relates to a method for presenting logically merged contact information of a first contact, said method having the steps of discovering, using one or more processors that form part of a computing device of a second user intending to view merged contact information of the first contact, existence of a unique identifier of the first contact across one or more contacts stored in a plurality of contact directories accessible to the second user, and wherein the plurality of contact directories comprise at least one crowd sourced shared contact directory having a first user and the second user and having at least the first contact as common, wherein the at least one crowd sourced shared contact directory is crowd sourced so as to discover new contacts automatically based on actions of multiple contacts that are already a part of the shared contact directory; and merging and presenting, at the computing device, contact information attributes of the one or more contacts stored in the plurality of contact directories that have the unique identifier of the first contact, wherein the merging logically unifies the contact information attributes to present the merged contact information without actually merging the contact information attributes.

In an aspect, the present disclosure relates to contact linking and presentation of a merged view for duplicate contacts that exist across one or more shared/private contact directories (also interchangeably referred to as “phone books” or contact directories” hereinafter) to a user of such contact directories. Further, an ability to mark a particular contact related information as discarded is being disclosed in the instant disclosure. It is further proposed that while creating a temporary merged view (also interchangeably referred to as “logical merged view”, “logically merged view” or “virtual view”), such discarded information, when linked with other linked contacts, can also be enforced as discarded so as to prevent zombie information coming alive due to linking.

Aspects of the present disclosure provide a duplication detection engine (DDE) that is operatively coupled with a first computing device (such as a smartphone of a user), wherein the DDE is configured to retrieve/discover one or more contact directories that may be either stored locally on the first computing device or accessible from a common global database of contact directories that the first computing device is authorized to access. DDE can further be configured to identify duplicate contacts across the retrieved one or more contact directories using at least one unique identifier. In an aspect, the unique identifier can be the phone number of the contact whose duplicate entries exist across the one or more contact directories, or can be a combination of first and last name of the contact whose merged view is to be viewed, or can be the email address/home address/office address/or any other contact information attribute or a combination thereof, whose value is unique to the contact/user whose merged view is to be viewed. For instance, if the DDE is able to retrieve 5 contact directories (CDs), say CD-1, CD-2, CD-3, CD-4, and CD-5, three of which (say CD-1, CD-2, and CD-4) have a common contact for Alan having number 999-435-4368; three duplicate contacts can be said to have been identified by the DDE. It can also be possible, that CD-2, apart from storing the unique identifier, can also store say another phone number, say work number or another personal phone number. Other contact information such as email id, social media handle, URL, birthday details, address, photo etc., for Alan across the duplicate contacts may also be same or completely different or partially different.

Aspects of the present disclosure can further provide a merging engine that can be configured to, at the first computing device, logically/temporarily merge the duplicate contacts at its run-time to present a single merged view for each contact without actually merging the duplicate contacts across the contact directories. The proposed merging engine therefore may not change the entries in respective contact directories per se but can merge the duplicate entries only for the presentation to the user of the first computing device. Such a merged view can further give the number of contact directories in which duplicate entries exist, and/or number of duplicate entries for a given contact (such as 3 for Alan) across all contact directories. For instance, it may be possible that a given contact directory has multiple duplicate entries within itself, or it may also be possible that duplicate entries exist across multiple contact directories. In another aspect, the merging engine can further enable presentation of all contact directories that a given duplicate contact forms a part of.

In an exemplary aspect, users can share their respective one or more contact directories to enable the shared contact directories to form part of a group-sourced (also referred as crowd-sourced hereinafter) contact directory database. For instance, user A can store one or more contact directories, say one for his college colleagues, one for office colleagues, one for family members, and one for school friends, among other like contact directories, wherein at least a few of these directories can be uploaded to group-sourced contact directory database once the user A signs up with the proposed system (coupled with the database), wherein the uploaded contact directories can be automatically shared with members of the respective directories. For instance, in case user A has 3 directories D1, D2, and D3 with directory D1 having contact details of users A, B, C, D, and E, the directories can be uploaded automatically or manually by the user A onto the group-sourced contact directory database such that upon uploading, a notification can be automatically sent to users B-E giving them access to the shared contact directory D1 at the group-sourced contact directory database. Similar actions can be performed for other directories D2 and D3 as well.

In addition, when a new contact/user is added to a shared contact directory (also simply referred to as shared directory hereinafter), the new contact automatically becomes a member of the shared directory, wherein the new member can be notified of his/her inclusion into the shared directory. In an aspect, the new member can accordingly be provided access to the contact information of other members of the shared directory such that the new member can edit his/her own contact information or of other members' contact information within the directory.

It is to be appreciated that in the instant disclosure, reference to a “user” can be interchangeably interpreted to include reference to a “contact” of a contact directory, be it a shared directory or a private directory. A user therefore need not be an active user of a shared directory but can only be silent user who has been added, for instance, by another user. For example, user A of a shared directory SD1 can add a user B to the shared directory SD1, wherein the user B can then view all the contacts/uers that form part of the shared directory SD1 but may be an active user of the directory SD1 per se and simply have been just added to the directory, in which case also they are interchangeably referred to as user/contact of the present system. It would also be appreciated that a user becomes a user not only by registering with the proposed system but can also become a user based on connection with an already registered user or by automatically getting added to the proposed system/shared contact directories based on actions of other users.

When a user therefore gets access to multiple contact directories, it is quite possible that a given contact exists in multiple directories or multiple times in the same directory, which can be identified based on say a unique identifier such as the mobile phone number of the contact to accordingly determine the number of times the duplicate entry exists, and contact directories in which such entries exist. The proposed system can then be configured such that mobile phone number of contacts can be used to match contacts at a user device to link two or more contacts with same mobile phone number and belonging to at least two contact directories out of which at least one contact directory is a shared phonebook. The linking may further facilitate merging of such linked contacts in an automated way or by requiring user intervention. In an exemplary embodiment, the proposed system allows a combined/merged view at the user device of multiple duplicate contacts from one or more contact directories through logical/temporary merging/unification, without actually merging the contacts (or without deleting duplicate contacts). The proposed merged view can be presented such that all phonebooks that the duplicate contacts form a part of are represented in the merged view. The proposed merged view can further present the number of phonebooks that the duplicate contacts form part of. Even if a given phonebook has duplicate contacts, the contacts may not be merged totally (at the backend or even in the mobile smart-phone) but can only be shown as a merged view/presentation giving details of the number of times the contact is stored in each phonebook.

In an instance, if a user A has say 5 contact directories (each contact directory having multiple contacts) accessible on his/her mobile device (that can also be a mobile phone or a smartphone, the terms being used interchangeably herein), 3 of which store the contact number of Alan (having the same number of Alan or at least one common number), merged presentation/view of the contact for Alan on user A's mobile phone can show a single entry for Alan with 3 phonebooks being mentioned to illustrate that Alan's number is stored across 3 contact directories. When user A then selects Alan's entry while searching for Alan, the presentation can show a single entry for Alan with details of the contact directories on which the number is stored (along with the actual contact number(s) of Alan). It would be appreciated that the 3 entries for Alan across the 3 phonebooks are actually not merged (but instead only logically/temporarily unified), and therefore still exist as 3 different entries on the phonebooks, and only the presentation of the contact is changed to show a merged view rather than 3 different entries for Alan.

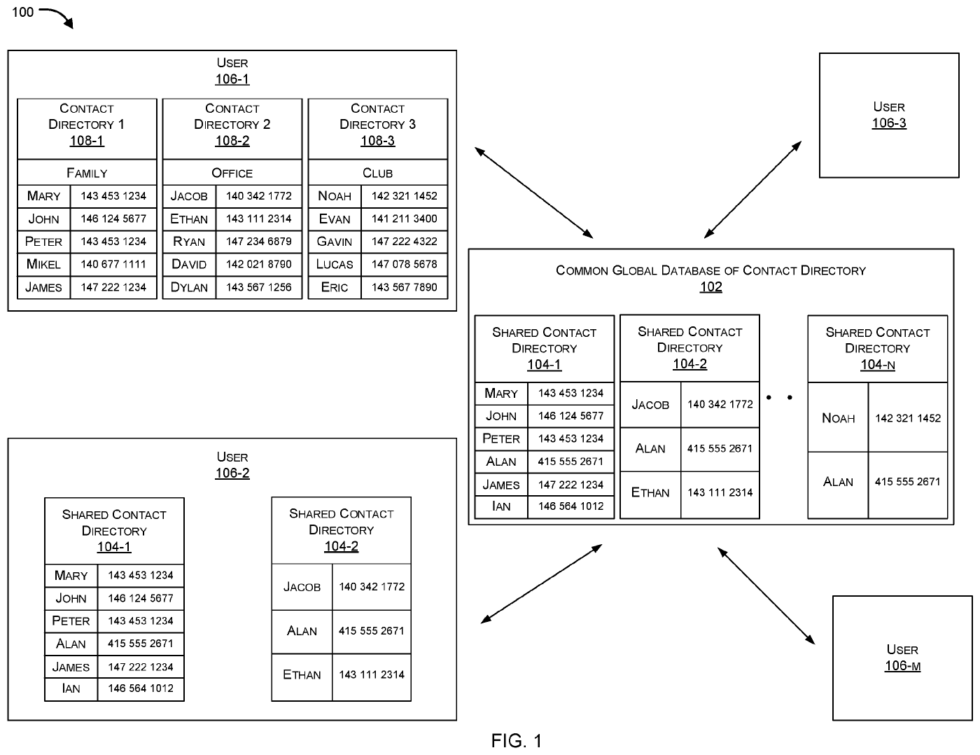

FIG. 1 illustrates an exemplary network architecture 100 showing multiple contact directories that are stored in a common global database of contact directories, and enabling users to access one or more shared contact directories depending on whether they (the users) form part of the respective contact directories in accordance with an embodiment of the present disclosure. As can be seen, common global database of contact directories 102 can include a plurality of shared contact directories 104-1, 104-2, . . . , 104-n (collectively referred to as shared contact directories 104) that are shared and grown by multiple users through say a crowd-sourcing mode. For instance, user 106-1 can have three contact directories 108-1, 108-2, and 108-3, each having 5 phone numbers such that when the user 106-1 signs up with the proposed system, the three contact directories 108-1, 108-2, and 108-3 (or any part thereof) can be uploaded automatically to update the common global database of contact directories 102 and be represented as shared contact directories 104. Members of the shared contact directories 104 can then be notified so as to enable their respective contact directories to be updated/added.

In an instance, if Alan (user 106-2) forms part of shared contact directories 104-1 and 104-2, both the contact directories 104-1 and 104-2 can be shown in the mobile device of Alan (user 106-2). In such a scenario, it is therefore possible that when user 106-2 searches for say “Tom Wilson”, phone number of a given contact can be present in multiple shared contact directories 104 (say in the contact directory of “school friends” as well as contact directory of “sport club members” and even in the contact directory of “squash players”). In such a case, instead of showing “Tom Wilson” multiple times in the contact list, which would cause clutter and redundancy in presentation to users, the present invention can be configured to enable a merged view of the contact to be presented, wherein the merged view can be a single entry per contact along with showing number of times that different or same contact directories store the contact information, along with the names of the contact directories that store the contact information. Therefore, no change is per se done in the contact directories themselves, but instead only the merged view is presented without actually merging the duplicate contacts or deleting the duplicate contacts.

In an aspect, while presenting the merged view, in case different duplicate contacts have different contact information, the merged view can represent an aggregate contact information showing all or the most reliable information. For instance, one duplicate contact can have contact information as “phone number as 999-999-9999”, “email id as abc@abc.com”, and “URL as abcabc.com”, whereas another duplicate contact can have contact information as “phone number as 999-999-9999”, “office phone number as 0244-3345667”, “address as B-240, ABC City”, and Emergency number as “111-111-1111”. In such a case, the merged view can show the combined contact information for the duplicate contact. In case of a conflict of a contact information parameter/attribute between the two duplicate contacts, one of the two contact information parameter value can be selected for presentation based on a defined rule (such as latest set contact information parameter) or both values for the contact information parameter can be presented. Any other variation is completely within the scope of the present disclosure.

In another instance, in case the contact/user names of a given contact (having the same unique identifier) are different across duplicate instances in one or more contact directories, any one or the most reliable or the most recent or the most redundant can be used and even edited by the user if desired. For instance, if in the contact directories of user Matthew Ark, five instances of user “Susan Hurley” (say Susan Hurley, Suan Hurley, Susaan Hurlay, Susan H, S. Hurley) are present across multiple contact directories with the same phone number, any of the five, or the most reliable/complete of the five can be chosen. In an alternate embodiment, all or a few of the five contact name variations can also be shown depending on the system's configuration, and therefore all such possible embodiments, implementations, and variations are completely within the scope of the present disclosure.

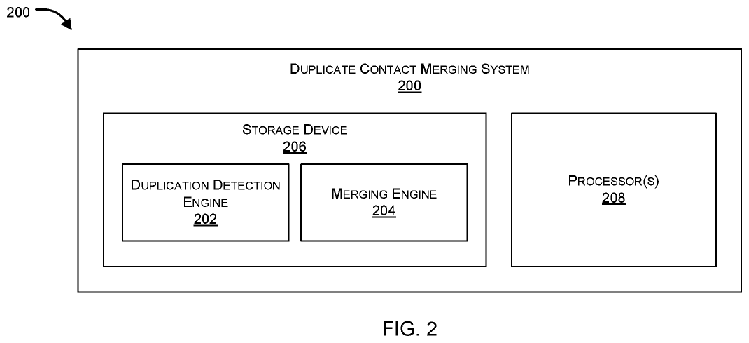

FIG. 2 illustrates exemplary functional modules of the proposed system 200 for showing a merged view of duplicate contacts stored across one or more contact directories in accordance with an embodiment of the present disclosure. Aspects of the present disclosure provide a duplication detection engine (DDE) 202 that can be operatively coupled with a first computing device (such as a smartphone or a mobile phone of a user), wherein the DDE 202 can be configured to retrieve one or more contact directories that may either be stored locally on the first computing device or can be accessible from a common global database of contact directories that the first computing device is authorized to access. It would be appreciated that although the present disclosure is described with respect to a single common global database, any number of databases, repositories, or data structures can be configured to store one or more shared contact directories that can either be discovered by a discovery engine or can be shared by different users.

In an aspect, DDE 202 can further be configured to identify duplicate contacts across the retrieved one or more contact directories using at least one unique identifier. In an aspect, the unique identifier can be the phone/mobile number of the contact whose duplicate entries exist across the one or more contact directories. For instance, if the DDE 202, for a given user that uses the above first computing device, is able to retrieve 5 contact directories (CDs), say CD-1, CD-2, CD-3, CD-4, and CD-5, three of which (say CD-1, CD-2, and CD-4) have a common contact for “Alan” having unique identifier (phone number) 999-435-4368; three duplicate contacts can be said to have been identified by the proposed DDE 202. It can also be possible that CD-2, apart from storing the unique identifier, can store say another/second phone number (such as work/office number or another personal phone number). Other contact information such as email id, social media handle, URL, birthday details, physical address, photograph, for Alan, across the duplicate contacts, may also be same or completely different or partially different. It is also be appreciated that contact directories may not be explicitly retrieved by users from a common contact directory database but can be shared between users. For instance, user A can share his/her multiple contact directories (for say work, home, club, travel) directly with user B without actually going through a common contact directory database. Any other like implementation for getting access to one or more contact directories having (or even without) a defined context (such as work, family, alumni, college, pen pals) is completely within the scope of the present disclosure, wherein the DDE 202 is basically configured to retrieve, from a defined number of contact directories, number of duplicate entries for a given contact.

Aspects of the present disclosure can further provide a merging engine 204 that can be configured to, at the first computing device, logically merge the duplicate contacts/entries/instances at its run-time to present a single merged view for each contact without actually merging the duplicate contacts across the contact directories. The proposed merging engine 204 therefore may not change the entries in respective contact directories per se but can simply be configured to merge the duplicate entries only for the purpose of presentation/view to the user of the first computing device. Such a merged view can also be configured to give the number of contact directories in which duplicate entries exist, and/or number of duplicate entries for a given contact (such as 3 for Alan) across all contact directories. For instance, it may be possible that a given contact directory has multiple duplicate entries within itself, or it may also be possible that duplicate entries exist across multiple contact directories. In another aspect, the merging engine 204 can further enable presentation of names/information of all contact directories that a given duplicate contact forms a part of.

In an aspect, the present disclosure relates to a system 200 for presenting logically merged contact information of a first user, wherein the system 200 can include a non-transitory storage device 206 having embodied therein one or more routines operable to present logically merged contact information; and one or more processors 208 coupled to the non-transitory storage device 206 and operable to execute the one or more routines, wherein the one or more routines can include a duplication detection engine 202, which when executed by the one or more processors 208 that form part of a computing device of a second user intending to view merged contact information of the first user, discovers existence of a unique identifier of the first user across one or more contacts stored in a plurality of contact directories, and wherein the plurality of contact directories comprise at least one crowd sourced shared contact directory that is shared across multiple contacts and is crowd sourced to discover new contacts automatically based on actions of the multiple contacts that are already a part of the shared contact directory.

In an exemplary implementation therefore, second user/contact can, in his/her phonebook, either search by a phone number or by the name of the first user/contact, wherein such a search can be conducted in all contact directories that the second user forms part of, few of which can be shared contact directories whereas the others can be private contact directories that only the second user has access to, for instance, locally stored contact directories. In an aspect, shared contact directories can also be stored locally on the mobile/smart phone of the second user, and can be synchronized in real-time with the corresponding shared contact directories that are stored on a server/cloud that is accessible to all users that have registered for such shared contact directory services. Therefore, any mode/manner/technique of searching in one or more contact directories is well within the scope of the present disclosure.

During this implementation, multiple instances may be identified for the first user, where the entered unique identifier such as the first/last name of the first user, or his/her phone number can be used to narrow down the search results to ones that share the unique identifier of the first user. All such identified instances/duplicate contact entries across a plurality of contact directories can then be shared with the merging engine 204. Each instance of first user can include multiple contact information attributes that may or may not be unique for that instance. For example, for first user, one instance in a first contact directory may store only the name and phone number of the first user, whereas another instance in a second contact directory may store the email and social media handle as well, and yet another instance in a third contact directory, may store the fax number, URL, and physical address. All such contact information attributes for each instance of first user are therefore well within the scope of the present disclosure. It should also be appreciated that multiple instances for first user may exist in a single contact directory itself.

The system can further include a merging engine 204, which when executed by the one or more processors 208, merges and presents contact information attributes of the one or more contacts stored in the plurality of contact directories that have the unique identifier, wherein the merging engine 204 logically unifies the contact information attributes to present the merged contact information without actually merging the contact information attributes.

In an aspect therefore, multiple instances found for the first user during the discovery phase by the engine 202, can be logically/temporarily merged/unified and presented to the second user. Such merging can, in an exemplary implementation, simply merge values of all contact information attributes present in each instance. In another aspect, only the unique values can be merged. For instance, if a first instance of the first user in a first contact directory has the landline number of 01202342010, and a second instance of the first user in a second contact directory has the landline number of 01202342011, and a third instance of the first user in a third contact directory has the landline number of 01202342010, the merged view can show the landline numbers as 01202342010 and 01202342011.

In an aspect, the unique identifier can be any or a combination of first name (such as Alan), last name (such as Baskar), email address (such as alan@gmail.com), phone number (such as 9810534567), URL (www.linkedin.com/alan), photograph (such as the actual image of Alan), address (such as B-342, Marine Drive, Mumbai, 234566), contact information attribute (such as any other contact information field that can even be a new field altogether that has been added by user), social media handle (such as twitter handle alan.baskar), or a part thereof. In another aspect, the computing device on which a user such as a second user can search for details of a first user can be selected from any of a mobile phone, a smart phone, a tablet PC, a laptop, and a PDA.

In yet another aspect, the crowd sourced shared contact directory can be stored on a server/cloud or on a database that is accessible to the computing device. The shared contact directory can also be stored on mobile/smart phone of another user that is connected through, for instance, Bluetooth, Wi-Fi, Internet, or any other means with device of the user that is intending to perform a search. For instance, user A may be doing a search for user B, where such a search can take place on any or a combination of local contact directories of user A, and shared contact directories that user A has access to, few of which may be stored on a server/cloud (or multiple servers) whereas few may be stored on mobile devices/phones of other users such as on the smart phone of user C that can have one or more shared directories with user A.

In another aspect, first user and second user can be connected such that they share at least one common contact directory. It is obvious that for user B to appear as a contact when user A searches for user B, user B has to be present in at least one local/shared contact directory, and therefore users A and B have to be connected with each other through at least one common contact directory.

Furthermore, in an aspect, at least one contact directory (such as a private contact directory) of the plurality of contact directories can be stored locally on the computing device.

In an aspect, the merged contact information can be presented along with directory information of the contact directories that the first user forms part of and are also accessible to the second user. In an instance, the directory information can include any or a combination of number of contact directories that the first user forms part of, number of contacts in each contact directory that the first user forms part of, and attributes of contacts that form part of the contact directories that the first user forms part of. Any other contact information attribute and value thereof that is configured to be visible to first user while viewing the logically unified contact information of a second user is well within the scope of the present invention. Such information can be shown on a single page/link or can shown iteratively as and when desired by the first user, all of which possible implementations are well within the scope of the present disclosure. In an aspect, details of all or a few directories that are common between searching user and searched user and that have instances of the searched user can be presented to the searching user such as the number of users that form part of each such common directory, purpose of the directory (office, family, sports, club, etc), creation date of the directory, among any other desired information.

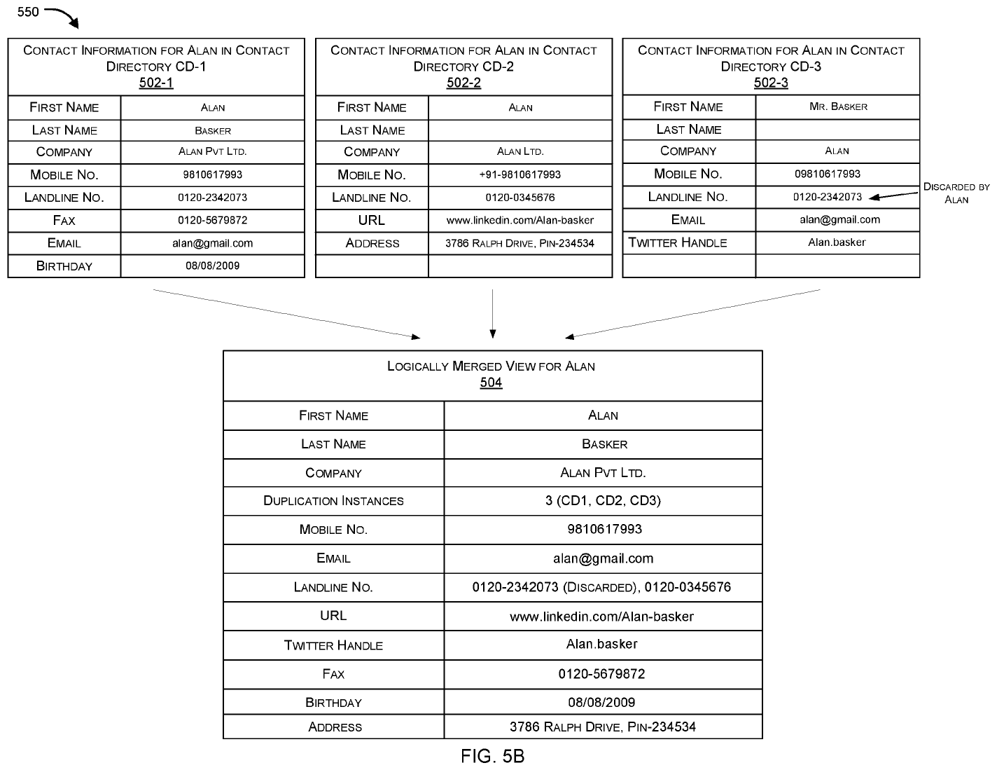

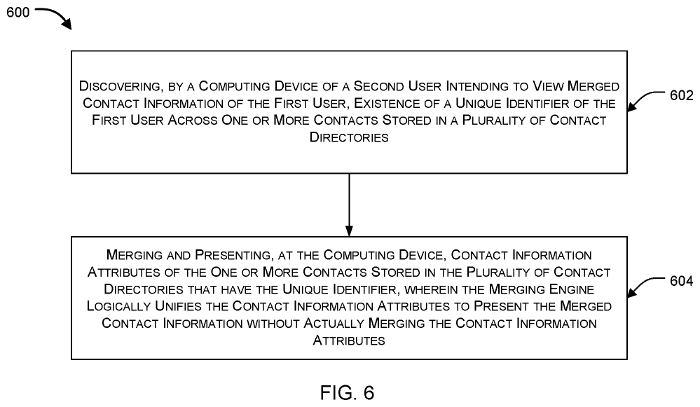

In another aspect, the system can enable the first user to discard an entry against a first contact information attribute such that in case the entry exists against the first contact information attribute for the first user across two or more contact directories, the second user views the entry as discarded in the merged contact information. For instance, with reference to FIG. 5B, if contact/user Alan marks his landline phone number 0120-2342073 as discarded in contact directory CD-3; when a user Bill searches for Alan and identifies two contact directories CD-1 and CD-3 that have the landline phone number 0120-2342073, the logically merged view can be configured to show the landline phone number 0120-2342073 as being discarded. Therefore, Alan, or any other user being searched for, need not mark a given entry in each contact directory that he forms part of as “Discarded”, and change in an entry of any contact directory instance is enough to enable all users searching for Alan to see that the local phone number (or any other marked/labeled entry) has been discarded by the owner of the entry.

In another aspect, modification of an entry against a contact information attribute of the first user in the merged contact information by the second user enables the modification to be performed in each such contact directory that stores the entry against the contact information attribute for the first user. For instance, in case CD-1 shows the email address of Alan as alan@gmail.com, and CD-2 shows the email address of Alan to be alanb@gmail.com, the second user, can while viewing both the email addresses in the merged view, depending on the authorization/permissions given by Alan, edit the email address to alan.b@gmail.com, which email can then change in all instances of Alan that have the email address field. However, as mentioned above, editing of contact information is based on configuration of the proposed system, and only allowed/authenticated users that have the necessary permissions can be allowed to edit the information.

In yet another aspect, when, against a contact information attribute, multiple different entries exist across the one or more contacts, the merging engine presents all the multiple entries in the merged contact information. Further, when, against a contact information attribute, a given entry exists across the one or more contacts, the merging engine removes the duplicates and presents the entry only once against the contact information attribute in the merged contact information.

In another aspect, the duplication detection engine can discover the one or more contacts stored in the plurality of contact directories that have the unique identifier based on a loose match (say for instance, a match for phone number 9810617223 of a first user can be said to have been found when a phone number (contact information attribute)+91-9810617223 or 09810617223 is found in a contact directory) of the unique identifier so as to improve the accuracy of discovery.

Similarly, even while presenting the merged contact information, contact information attributes values/entries can be merged based on a loose match. For instance, in case against contact information attribute such as landline phone, one entry/value is 0120-2342010 and another entry/value is +91-120-2342010, the merged representation can only show one entry, say +91-120-2342010. Therefore, in case the different entries against the contact information attribute loosely match with each other, the merged contact information only presents one of the losely matching entries.

In another aspect of the present disclosure, a first user of a given shared contact directory can mark contact information attribute value/entry of a first contact as discard such that when a second user that is part of shared contact directory and has the first contact common between itself and the first user, views the merged view for the first contact, the respective attribute value/entry is shown as discarded. For instance, a first user A can mark a given email address (say cc@gmail.com) of a first contact (say of user C) as discard such that when a second user B views the merged contact information attributes of user C, the email address cc@gmail.com can be shown as discarded.

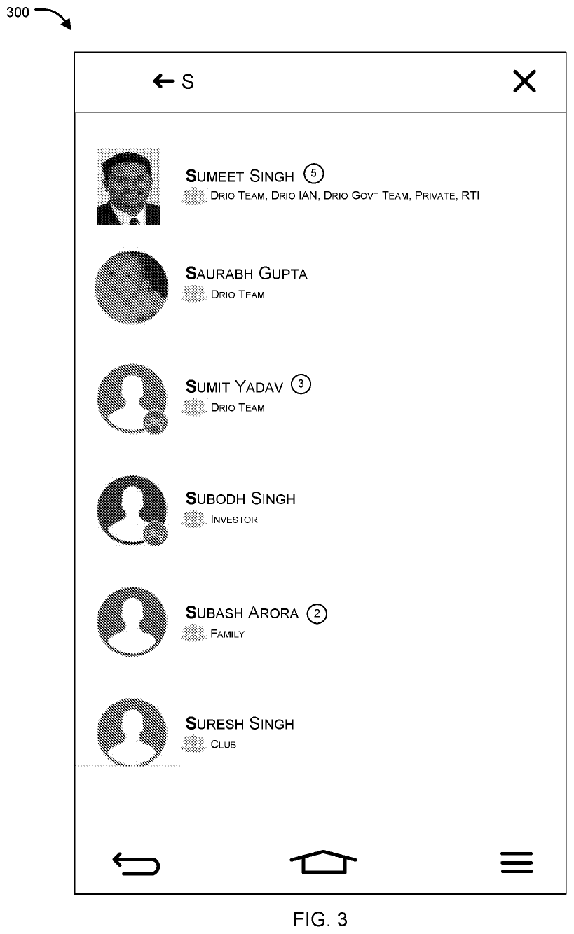

FIG. 3 shows an exemplary illustration of different contacts that are accessible to a user through one or more contact directories. As can be seen, when a user searches for “Sumeet Singh” by entering S in the “Search Contact” section, contact “Sumeet Singh” can be displayed indicating that the contact is actually stored 5 times across all the contact directories that the searching user has access to, i.e 5 instances of Sumeet Singh exist in all directories (local and/or shared) that the search user has access to. Such contact directories can either be user's own contact directory (phonebook that comes by default with the phone), or can be retrieved directly from a crowd-sourced system (such as from a common contact directory database) that stores multiple contact directories from multiple users (and hence is updated accordingly in real-time).

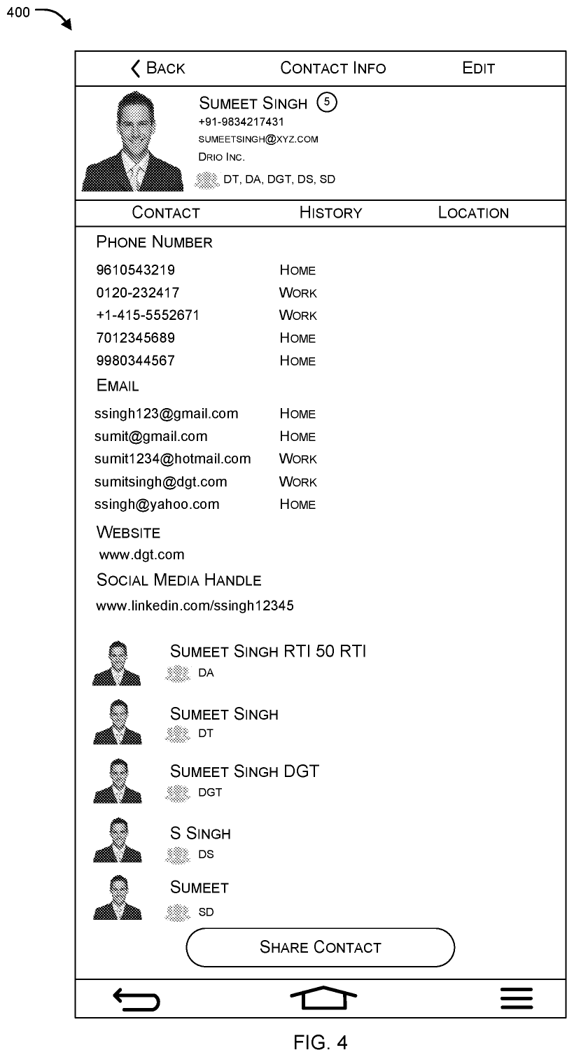

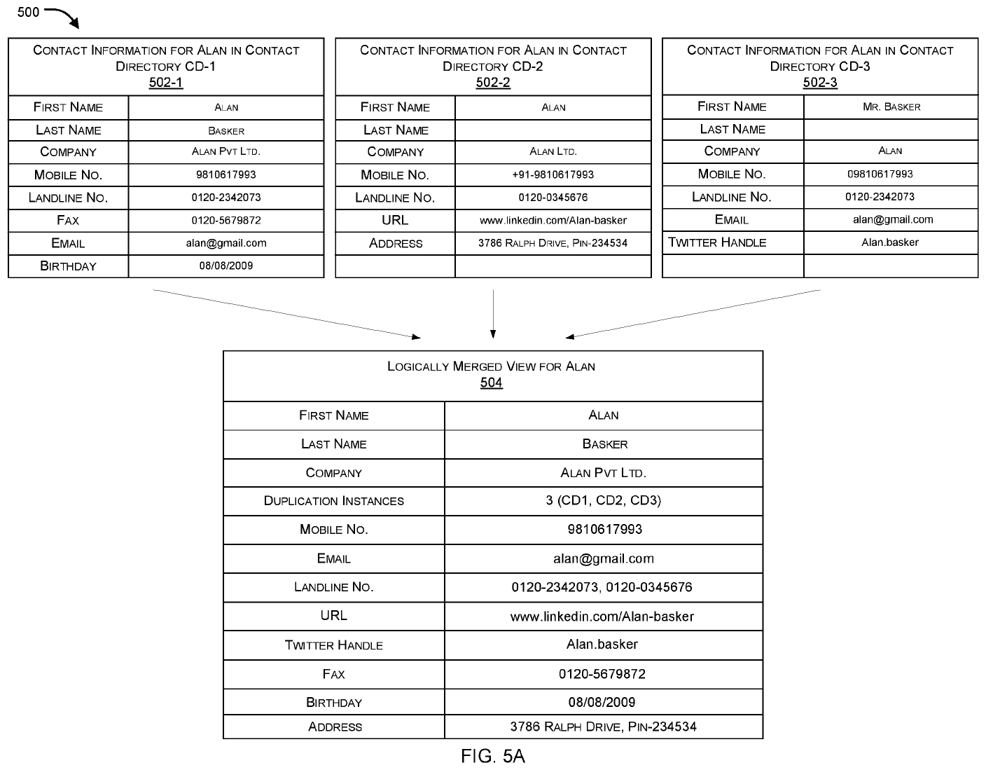

FIG. 4 illustrates an exemplary representation showing details when the user actually clicks on the contact “Sumeet Singh”, wherein all the contact directories that store the contact “Sumeet Singh” are represented as links. For instance, in FIG. 4, for user “Sumeet Singh”, contact directories “RTI”, “50 RTI”, “Diro Team”, “Diro IAN”, “Diro Govt Team”, and even user's primary contact directory (that comes along with the user's mobile phone) are shown, indicating that all these contact directories have duplicate entries for “Sumeet Singh”. Contact information for the user “Sumeet Singh” can be merged and shown in a merged view. User can also be enabled to click on any contact directory link and view the directory along with the contact information for the duplicate contact that the respective directory stores.

In an aspect, merged view links all the duplicate contact entries across one or more contact directories to enable single contact information to be presented. In an aspect, such merged view has a technical effect of not actually changing any attribute in the original contact directories in the backend, but instead unifying the duplicate contacts across one or more contact directories in real-time to present the logically/temporarily merged view, which takes much lesser memory and utilizes much lesser computing resources than presenting all the duplicate contacts individually, and hence the claimed subject matter has a clear technical effect and also enables this effect in a manner that is manually not possible to achieve. In an aspect, linking of duplicate contacts preferably happens on the user's mobile device and the data is not actually linked to cause any changes in the shared contact directory(ies) for other users. Furthermore, merged view of duplicate contacts can be customized differently for every user's mobile/portable/smartphone device. Merged view shown on one mobile phone may not therefore impact how another user of the same shared contact directories views the duplicate contacts. In another aspect, any other matching pattern and/or artificial intelligence may be used to link such contacts.

In an exemplary embodiment, contacts' email or phone number can be used to link the duplicate contacts, and then further a loose match as elaborated here can be applied on the names. In another embodiment, the unique identifier that can be used to merge the duplicate contacts for view/presentation purposes can be based on the email identifier of the duplicate contact and one of its phone number. That is, a contact can be determined to be a duplicate of another only when both its email identifier as well as one of its phone number match to that of the another. In another aspect, once all the duplicate contact entries for a given phone number/email id/unique identifier have been identified, the merging action can be performed based on name of the contact, i.e., only contacts having a common first name can be shown in the merged representation and others can be shown separately. For instance, in case five duplicate contacts have the same phone number 981-063-4564, their names could be “Bruce Dawson”, “Bruce D”, “Burc Dawson”, “Bruce Home”, “Bru Off”, in which, in one instance all the contacts can be shown in a single merged representation with any or a chosen/defined name, or else, only contacts having the correct first name (i.e. “Bruce Dawson”, “Bruce D”, and “Bruce Home”) can be shown in the merged representation. Any other embodiment is completely within the scope of the present disclosure.

In an exemplary aspect, linking of duplicate contacts may be temporary or permanent, wherein it may be done dynamically at the time of search or at the time of generating a list of contacts. In an exemplary embodiment, the proposed merged view of duplicate contacts/entries can be implemented across a plurality of shared contact directories across multiple users where the duplicate contacts contact can be merged based on the contact directories accessible to a given user to look like a single contact on a temporary basis. Such an aspect can be particularly relevant for a crowd-sourced phonebooks platform as described in PCT/US2015/019443.

In an aspect, system of the present disclosure may take into account status of contacts in directories such as archived directories, discarded directories, and privacy controls based directories. In another exemplary embodiment, contact behavior in the contacts directory may be made to perform as a single contact like making a call, SMS, or even some edit functions that are very distinct from a dedupe or merge contact function normally available. In an aspect, editing a contact field in a merge view may update that field in all linked contacts simultaneously.

In another aspect of linking the information labels for the contact information are used to cause linked contacts to merge differently at run time for example if the phone number is marked “private” in a shared phonebook then it is masked during display. However, if the same phone number is also stored in a private phonebook then it gets unmasked during link view. On the contrary, in a discarded label, the merge view overrides all other labels if at least one of the labels attached to the information is “discarded”

In another aspect of the merge view engine, the information may be normalised before and/or after the aggregation of contact information within the linked contacts to facilitate aggregation or display of information.

In yet another aspect, it is also possible for a user/contact to discover all instances of himself across all contact directories and then view a merged representation of all the instances so as to be able to edit one or more contact information attributes.

In another aspect, the native data stored on the user device may be used to override the display format of the similar information like in case of name, address.

In another embodiment, the contact history or notes are also combined in a merged view.

While generating the merge view, matching data elements may be combined based on user contact directory/phonebook preferences or statistical AI (artificial intelligence) based inferences. Further, a facility to tag discarded information may be provided that can get automatically hidden from view or marked disabled/discarded at the time of view from all dynamically linked contacts at the user level. This can strike a balance between merging and preventing information leaking into shared phonebooks by not permanently merging the data.

FIG. 5A illustrates temporary merging of contact information attributes present for a contact, instances of which are present across multiple contact directories. As can be seen, three contact directories CD-1 502-1, CD-2 502-2, and CD-3 502-3, can include instances of contact “Alan”, wherein each instance can include one or more contact information attributes such as first name, last name, email address, URL, social media account identifier, phone number, landline number, fax number, company, and birthday, among others. Additional contact information attributes can also be defined by the owner of the contact. When another user, say Bill, wishes to view the contact for Alan, he can search for Alan in his phonebook/contact directory, and then discover all instances of Bill across one or more contact directories wherever Bill's unique identifier exists, and can see the merged view as shown in 504, wherein artificial intelligence, statistical correlation, historical pattern, self-learning architectures, coherence techniques, among other like mechanisms can be used to present the merged view. In case different entries exist for a given contact information attribute, all the different entries can be presented. FIG. 5B illustrates a scenario where Alan marks/labels one of his entries (landline number) in one contact directory (CD-3) as discard, by which when Bill views the merged view, he can see the respective landline number being marked as discarded.

FIG. 6 illustrates an exemplary flow diagram 600 for presenting merged view of contact information attributes of contact instances across one or more contact directories in accordance with an embodiment of the present disclosure. In an aspect, a method for presenting logically merged contact information of a first user is disclosed, wherein, at step 602, the method can include the step of discovering, by a computing device of a second user intending to view merged contact information of the first user, existence of a unique identifier of the first user across one or more contacts stored in a plurality of contact directories, and wherein the plurality of contact directories comprise at least one crowd sourced shared contact directory that is shared across multiple contacts and is crowd sourced to discover new contacts automatically based on actions of the multiple contacts that are already a part of the shared contact directory. At step 604, merging and presenting, at the computing device, contact information attributes of the one or more contacts stored in the plurality of contact directories that have the unique identifier, wherein the merging engine logically unifies the contact information attributes to present the merged contact information without actually merging the contact information attributes.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

We claim:

1. A system for presenting logically merged contact information of a first contact, said system comprising:
a non-transitory storage device having embodied therein one or more routines operable to present logically merged contact information; and
one or more processors coupled to the non-transitory storage device and operable to execute the one or more routines, wherein the one or more routines include:
a duplication detection engine, which when executed by the one or more processors that form part of a computing device of a second user intending to view merged contact information of the first contact, discovers existence of a unique identifier of the first contact across one or more contacts stored in a plurality of contact directories accessible to the second user, and wherein the plurality of contact directories comprise at least one crowd sourced shared contact directory having a first user and the second user and having at least the first contact as common, wherein the at least one crowd sourced shared contact directory is crowd sourced so as to discover new contacts automatically based on actions on multiple contacts that are already a part of the shared contact directory; and
a merging engine, which when executed by the one or more processors, merges and presents contact information attributes of the two or more contacts stored in the plurality of contact directories that have the unique identifier of the first contact, wherein the merging engine logically unifies the contact information attributes to present the merged contact information without actually merging the contact information attributes.

2. The system of claim 1, wherein the unique identifier is any or a combination of first name, last name, email address, phone number, URL, photograph, address, a new contact information attribute, date based events, social media handle, or a part thereof.

3. The system of claim 1, wherein the computing device is selected from any of a mobile phone, a smart phone, a tablet PC, a laptop, and a PDA.

4. The system of claim 1, wherein the at least one crowd sourced shared contact directory is stored on a server or on a database that is accessible to the computing device.

5. The system of claim 1, wherein at least one contact directory of the plurality of contact directories is stored locally on the computing device.

6. The system of claim 1, wherein the merged contact information is presented along with directory information of the contact directories that the first contact forms part of and are also accessible to the second user.

7. The system of claim 6, wherein the directory information comprises any or a combination of number of contact directories that the first contact forms part of, number of contacts in each contact directory that the first contact forms part of, and attributes of contacts that form part of the contact directories that the first contact forms part of.

8. The system of claim 1, wherein the system enables the first user to discard an entry against a first contact information attribute of the first contact such that in case the entry exists against the first contact information attribute for the first contact across two or more contact directories, the second user views the entry as discarded in the merged contact information.

9. The system of claim 1, wherein first contact is of the first user.

10. The system of claim 1, wherein modification of an entry against a contact information attribute of the first contact in the merged contact information by the second user enables the modification to be performed in each instance of the first contact across the one or more contact directories that are accessible to the second user and store said entry against the contact information attribute for the first contact.

11. The system of claim 1, wherein when, against a contact information attribute, multiple different entries exist across the one or more contacts having the unique identifier of the first contact, the merging engine presents all the multiple entries in the merged contact information.

12. The system of claim 1, wherein in case the different entries against the contact information attribute loosely match with each other, the merged contact information only presents one of the losely matching entries.

13. The system of claim 1, wherein when, against a contact information attribute, a given entry exists across the one or more contacts, the merging engine removes the duplicates and presents the entry only once against the contact information attribute in the merged contact information.

14. The system of claim 1, wherein the duplication detection engine discovers the one or more contacts stored in the plurality of contact directories that have the unique identifier based on a loose match of the unique identifier so as to improve the accuracy of discovery.

15. A method for presenting logically merged contact information of a first contact, said method comprising the steps of:
discovering, using one or more processors that form part of a computing device of a second user intending to view merged contact information of the first contact, existence of a unique identifier of the first contact across one or more contacts stored in a plurality of contact directories accessible to the second user, and wherein the plurality of contact directories comprise at least one crowd sourced shared contact directory having a first user and the second user and having at least the first contact as common, wherein the at least one crowd sourced shared contact directory is crowd sourced so as to discover new contacts automatically based on actions of multiple contacts that are already a part of the shared contact directory; and
merging and presenting, at the computing device, contact information attributes of the one or more contacts stored in the plurality of contact directories that have the unique identifier of the first contact, wherein the merging logically unifies the contact information attributes to present the merged contact information without actually merging the contact information attributes.

16. The method of claim 15, wherein the unique identifier is any or a combination of first name, last name, email address, phone number, URL, photograph, address, a new contact information attribute, date based events, social media handle, or a part thereof.

17. The method of claim 15, wherein the at least one crowd sourced shared contact directory is stored on a server or on a database that is accessible to the computing device.

18. The method of claim 15, wherein at least one contact directory of the plurality of contact directories is stored locally on the computing device.

19. The method of claim 15, wherein the merged contact information is presented along with directory information of the contact directories that the first contact forms part of and are also accessible to the second user.

20. The method of claim 19, wherein the directory information comprises any or a combination of number of contact directories that the first contact forms part of, number of contacts in each contact directory that the first contact forms part of, and attributes of contacts that form part of the contact directories that the first contact forms part of.

21. The method of claim 15, wherein the system enables the first user to discard an entry against a first contact information attribute of the first contact such that in case the entry exists against the first contact information attribute for the first contact across two or more contact directories, the second user views the entry as discarded in the merged contact information.

22. The method of claim 15, wherein modification of an entry against a contact information attribute of the first contact in the merged contact information by the second user enables the modification to be performed in each instance of the first contact across the one or more contact directories that are accessible to the second user and store said entry against the contact information attribute for the first contact.

23. The method of claim 15, wherein when, against a contact information attribute, multiple different entries exist across the one or more contacts having the unique identifier of the first contact, the merging engine presents all the multiple entries in the merged contact information.

24. The method of claim 15, wherein in case the different entries against the contact information attribute loosely match with each other, the merged contact information only presents one of the losely matching entries.

25. The method of claim 15, wherein when, against a contact information attribute, a given entry exists across the one or more contacts, the merging engine removes the duplicates and presents the entry only once against the contact information attribute in the merged contact information.

26. The method of claim 15, wherein the step of discovering identifies the one or more contacts stored in the plurality of contact directories that have the unique identifier based on a loose match of the unique identifier so as to improve the accuracy of discovery.
